(19) United States
(12) Patent Application Publication
(10) Pub. No.: US 2005/0111668 A1
(43) Pub. Date: May 26, 2005

(54) Dynamic source authentication and encryption cryptographic scheme for a group-based secure communication environment

(76) Inventor: Amit Raikar, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/722,822

(22) Filed: Nov. 25, 2003

(51) Int. Cl. H04L 9/00

(52) U.S. Cl. 380/278

(57) ABSTRACT

Embodiments of the present invention include a method for establishing secure group-based communication comprising: distributing a first set of keys to a plurality of hosts for encrypting communication and for source authentication of group-based communication between the plurality of hosts. The method further includes distributing a second set of keys to the plurality of hosts for dynamically modifying the first set of keys as also any other keys used (encryption keys or seed variables) when required (viz. for periodic re-keying or for adjusting to a change in group membership).

### TECHNICAL FIELD

Embodiments of the present invention relate to the field of communications and more particularly to secure group-based communications.

### BACKGROUND ART

Many communication environments allow members to communicate with each other in a group manner. For example, members of a particular group can multi-cast a message to all members of the group at one time. Although convenient, group-based communications do not provide secure communication between each of the members.

To enhance security of communication between members of a group-based communications environment, message authentication codes (MACs) are used to authenticate members of a group. A message authentication code (MAC) is an authentication tag (e.g., a checksum) generated by an authentication scheme, together with a secret key, and attached to messages passed between group members.

FIG. 1 is an illustration of a prior art group-based communications environment 100 wherein MACs are used to authenticate members of a group. Host A 101, host B 102 and host C 103 are members of a group and can communicate in a group manner. To provide secure group-based communication, each member of the group comprises secrete key 110 that is used to encode messages sent to other members of the group and decode messages from members of the group. For example, when multicasting a message 120 to host B102 and host C 103, host A 101 encrypts the message 120 with the secrete key 110 and attaches MAC 125. Host B 102 and host C 103 can decode the message with secrete key 110 and can authenticate host A 101 with MAC 125.

In this prior art example, every host in the group uses the shared secrete key 110 for authenticating members. Since all members of the group use the same key, it is possible for a member of the group to spoof the system and multicast a message that appears to originate from another group member. Thus, this scheme does not provide true source host authentication, which may be required for a secure group communication. In addition, when a host leaves or is removed from the group, it is difficult to re-key the secrete key for each group member to prevent the removed host from reading confidential group information.

A group-based communications environment that authenticates a communication source and self-adjusts the protection schemes when a group member is added or removed from the group would be an improvement over the conventional art.

### DISCLOSURE OF THE INVENTION

A method for establishing secure group-based communication is disclosed. Embodiments of the present invention include a method for establishing secure group-based communication comprising: distributing a first set of keys to a plurality of hosts for encrypting communication and for source authentication of group-based communication between the plurality of hosts. The method further includes distributing a second set of keys to the plurality of hosts for dynamically modifying the first set of keys as also any other keys used (encryption keys or seed variables) when required (viz. for periodic rekeying or for adjusting to a change in group membership).

### BRIEF DESCRIPTION OF THE DRAWINGS

The above and other objects and advantages of the present invention will be more readily appreciated from the following detailed description when read in conjunction with the accompanying drawings, wherein:

FIG. 1 is a prior art illustration of a conventional communication environment wherein MACs are used to authenticate members of a group.

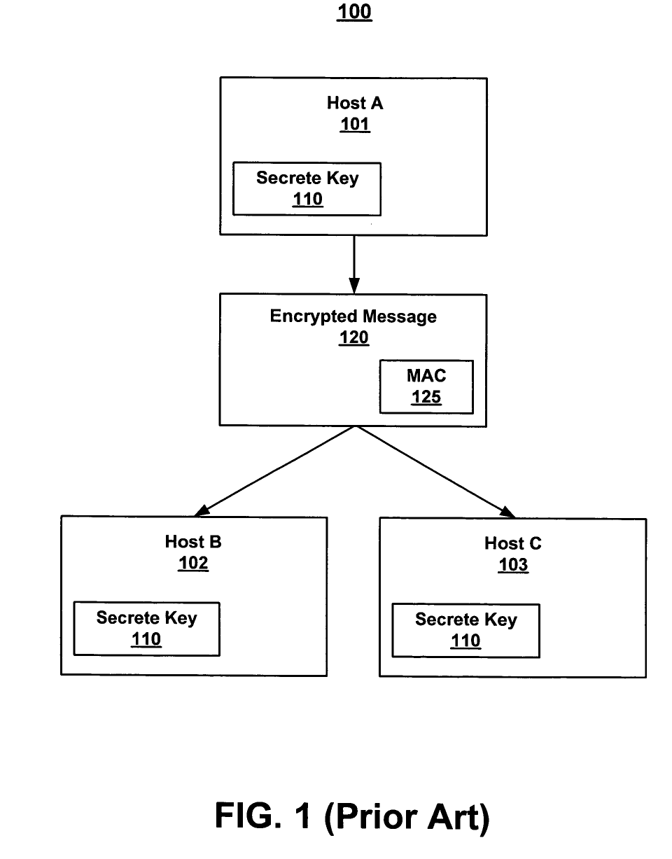

FIG. 2 is an illustration of an exemplary utility data center in accordance with embodiments of the present invention.

FIG. 3 is a block diagram of an exemplary group-based communications environment for dynamic source authentication in accordance with embodiments of the present invention.

FIG. 4 is a block diagram of an exemplary set of keys for dynamic source authentication in accordance with embodiments of the present invention.

FIG. 5 is a data flow diagram of an exemplary process for establishing a secure group-based communication environment for dynamic source authentication in accordance with embodiments of the present invention.

FIG. 6 is a block diagram of an exemplary computer system in accordance with embodiments of the present invention.

### DETAILED DESCRIPTION OF THE INVENTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention.

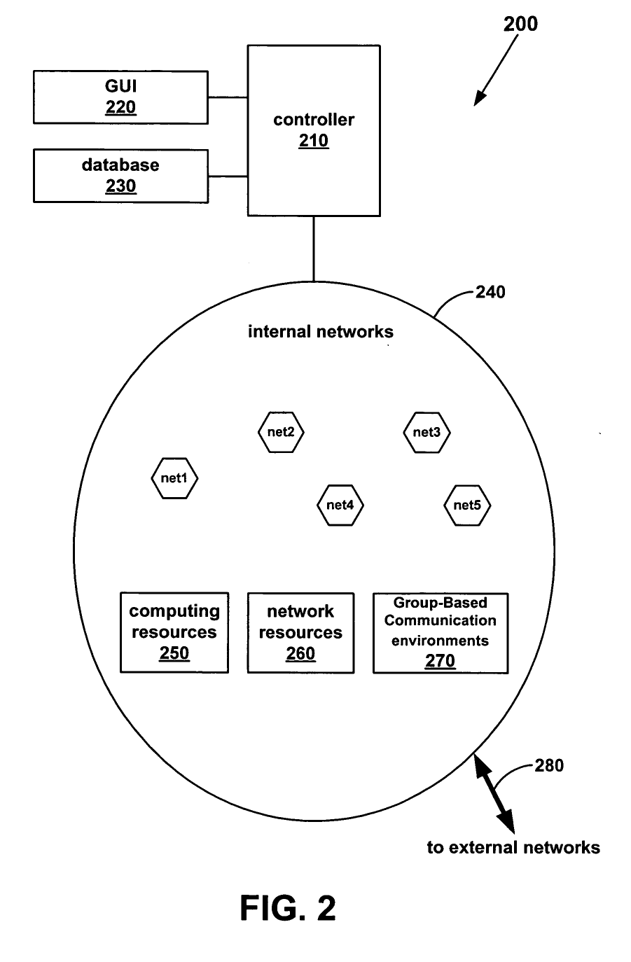

FIG. 2 illustrates a dynamic data center 200 in accordance with an embodiment of the present invention, showing a plurality of group-based communication environments 270. In the dynamic data center 200, the group-based communication environments 270 can be established to provide true source authentication for messages being multicast in the group based communication environments 270. In addition, the group-based communication environments can provide dynamic distribution and adjustment of keys used for source authentication when, for example, a member is added or removed from the group.

The dynamic data center 200 has a controller 210, a graphical user interface (GUI) 220, a database 230, a plurality of internal networks 240, and a communication link 280 to communicate with external networks (e.g., the Internet). The internal networks 240 include net1, net2, net3, net4 and net5. In practice, resources from the computing resources pool 250, the network resources pool 260, and the group-based communication environments 270 are selected to form the internal networks 240 (e.g., net1, net2, net3, net4 and net5). Moreover, the resources in the computing resources pool 250, the network resources pool 260, and the group communication environments 270 are networked and can be automatically and selectively organized into an internal network 240 (e.g., net1, net2, net3, net4 and net5) to provide a particular service (e.g., web site operation).

In an embodiment, there are various types of computing resources. Examples of these various types of computing resources include a server, a workstation, and a personal computer. In an embodiment, there are various types of networking resources. Examples of these various types of networking resources include a firewall, a gateway system, a network switch, and a network router.

Moreover, the dynamic data center 200 has the capability to provision an available resource from the computing resources pool 250, the network resources pool 260, and the group-based communication environments 270 to provide a service, whereas this provisioning can be performed via the controller 210. In an embodiment, the dynamic data center 200 is a utility data center (UDC) developed by the Hewlett-Packard Company. In particular, the controller 210 enables the control and configuration of the resources in the computing resources pool 250, the network resources pool 260, and the group-based communication environments 270 for the internal networks 40 (e.g., net1, net2, net3, net4 and net5). The GUI 220 enables a user to create a desired service supported by a network, which is then provided by a group of resources under the control of the controller 210. The database 230 includes information associated with each resource in the computing resources pool 250, the network resources pool 60, and the group-based communication environments 270. This information includes the configuration state of each resource.

Embodiments of the present invention provide true source authentication for messages being multicast in a group-based communications environment. Furthermore, embodiments of the present invention include dynamic distribution and adjustment of the keys used for source authentication and group authentication when, for example, a member is added or removed from the group. The dynamic distribution and adjustment of the keys used for authentication and validation prevents new members from accessing messages dated before they became a member and also prevents old members from reading messages dated after they were removed from the group. Dynamic adjustment of keys can also be used to periodically re-key the keys used for authentication and validation to further secure the communications environment.

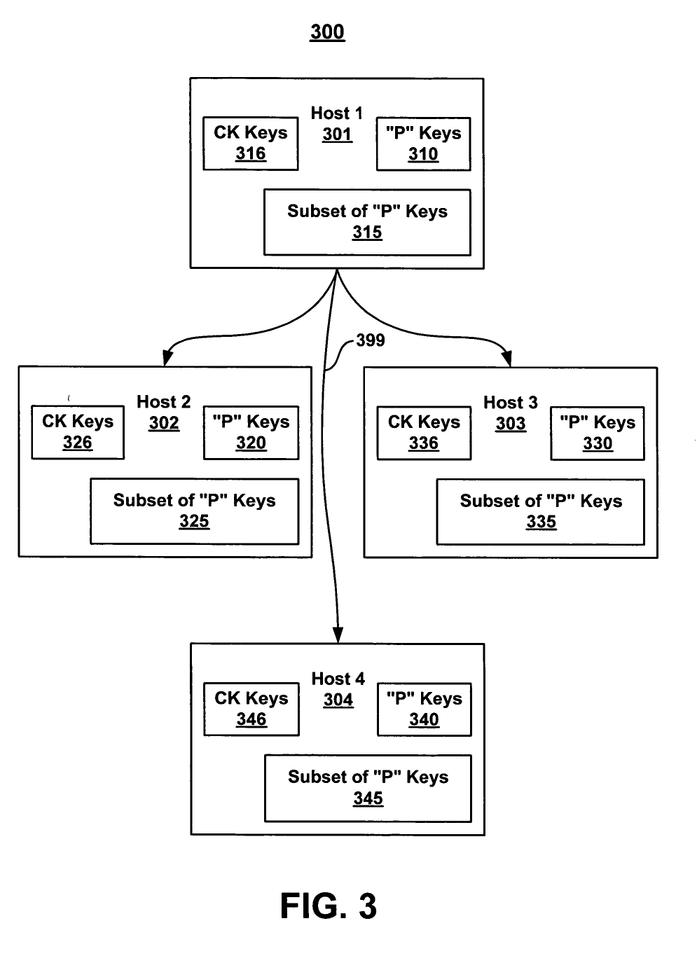

FIG. 3 is a block diagram of an exemplary group-based communication environment 300 for dynamic source authentication in accordance with embodiments of the present invention. Host one 301, host two 302, host three 303 and host four 304 are members of a communication group. The exemplary group-based communications environment 300 allows a group host to multicast a message to all members of the group. For example, host one 301 can multicast a message 399 to host two 302, host three 303 and host four 304 at one time.

Each host is distributed a set of “P” keys for generating MACs attached to outgoing messages, where “P” is the number of keys. The sender of a message to the group attaches “P” MACs to the outgoing message. The MACs are hashes on the packet message data created with each of the “P” keys. In one embodiment of the invention, no two hosts use the same set of sender keys (e.g., “P” keys) to encrypt an outgoing message. In other words, each host of the group is distributed a unique set of “P” keys for sending messages. For example, the “P” keys 310 of host one 301 will be different from “P” keys 320 of host two 302. Likewise, the “P” keys 330 of host three 303 will be different from the “P” keys 340 of host four 304.

Each receiver in the group is distributed a subset of the “P” keys with which it verifies authenticity of a subset of the MACs (e.g., according to the key the receiver holds), while the rest of the MACs can be assumed to be correctly authenticated. For example, host one 301 comprises subset keys 315, host two 302 comprises subset keys 325, host three 303 comprises subset keys 335 and host four 304 comprises subset keys 345. An appropriate choice of subset keys insures with a high probability that no coalition of up to “W” colluding Byzantine type of bad members know all of the keys held by a good member (wherein “W” is a parameter used to decide the number of keys a receiver is given for verifying authenticity). It is appreciated that many well-known statistical heuristics can be used to determine the parameter “W.” In addition to the “P” keys and the subset of “P” keys, each host of the group is distributed a set of complementary keys (e.g., CK keys). For example, host one 301 comprises CK keys 316, host two 302 comprises CK keys 326, host three comprises CK keys 336 and host four 304 comprises CK keys 346. The CK keys are used for key revocation when, for example, a host is added or removed from the group. The details of the CK keys will be discussed in more detail below.

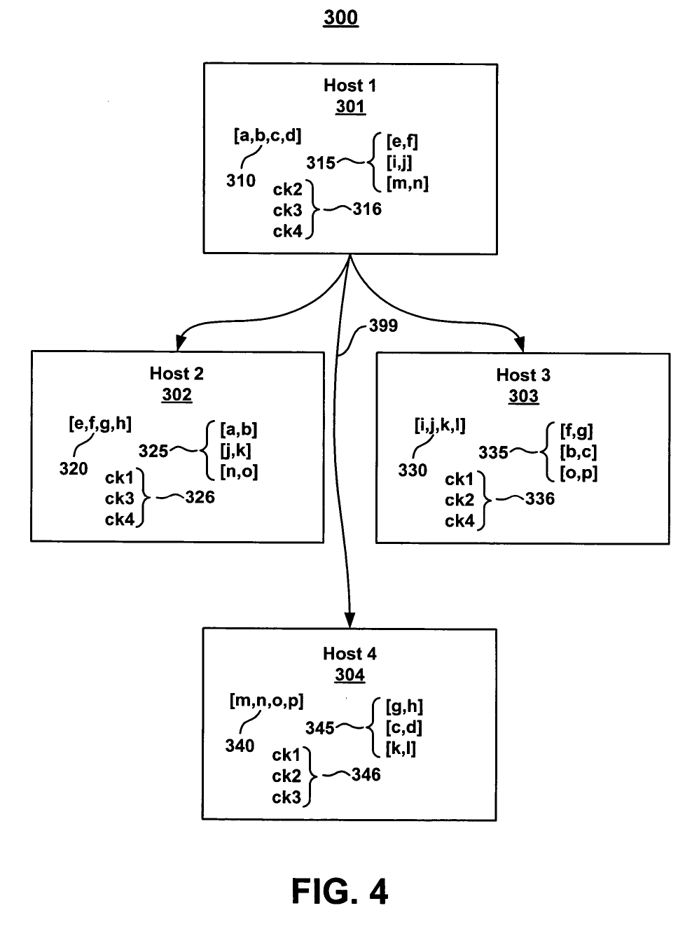

Referring now to FIG. 4, a block diagram of an exemplary set of keys for dynamic source authentication in accordance with embodiments of the present invention. As stated above, each host is distributed a set of “P” keys (e.g., “P” keys 310, 320, 330, 340 for host one 301, host two 302, host three 303 and host four 304 respectively) for creating MACs that are attached to a broadcast message 399. In addition to the “P” keys, each host is distributed a subset of “P” keys for verifying authenticity of a subset of the MACs and a set of CK keys used for key revocation when, for example, a host is added or removed from the group.

For example, host one 301 comprises a set of “P” keys 301, wherein “P” is equal to four. The four keys are [a,b,c,d] and are used for authenticating packets host one 301 sends to other members of the group. Each other host (e.g., group member) is distributed a subset of “P” keys of host one 301. For example, host two 302 comprises subset keys 325 that include the keys [a,b] (a subset of the “P” keys for host one 301). In addition to the [a,b] subset, host two 302 comprises the subset [j,k] from the “P” keys of host three 303 and the subset [n,o] from host four 304. Likewise, all of the other hosts comprise a unique subset of the “P” keys from each of the members of the group. In the embodiment described in FIG. 4, “P” is equal to four and “W” is equal to two (e.g., each set of “P” keys comprises four keys and each subset comprises two keys from the “P” keys of the other members).

In another embodiment of the invention, “W” could be any other number, for example, “W” could equal four. In this embodiment, one key would be distributed from each of the “P” keys to each host of the group. As the number of subset keys is lowered, the strength of the mechanism to check authentication is lowered. Thus, depending on the average size of the group, the set of authentication keys (e.g., “P” keys) used by the sender for authentication may be divided into an appropriate number of sets in accordance with embodiments of the present invention.

As stated above, in addition to the “P” keys used for uniquely authenticate messages from a sender and the subsets of the “P” keys used to verify authenticity of a subset of the MACs, each host is distributed a set of complementary keys (e.g., CK keys) used for dynamically modifying the “P” keys and the subsets of the “P” keys, for example, when adding or removing a host from the group. This set of complementary keys may also be used for dynamically modifying & readjusting the shared secret key (used for encrypting the group based communication) as also any other variables like key-generating seeds etc.

In one embodiment of the invention, every member “I” of a group size of “X” members is distributed “x-1” complementary keys. Each member “I” will have the complementary keys of all other members, denoted by CK1, except for its own complementary key. For example, host one 301 comprises complementary keys CK2, CK3, and CK4 corresponding to host two 302, host three 303 and host four 304, respectively. Host one 301 comprises the complementary keys for all other members of the group, except for its own complementary key. Furthermore, host two 302, host three 303 and host four 304 comprise the complementary key for host one 301 (e.g., CK1). As stated above, the complementary keys are used to re-key the “P” keys and the subsets of the “P” keys when, for example, a new member is added to the group.

In one embodiment of the invention, when a new member is proposed to being added to the group, the group chooses a master host dynamically to control the group just for the duration of the new member being added. In this embodiment, a master host can be chosen using either a deterministic rotation scheme or a complete non-deterministic group master election scheme. In another embodiment of the invention, the master host may be permanent, for example, if there is a host that owns the group or is the most trusted in the group.

The temporary or permanent master host uses an existing encryption key to communicate with the group. Then, in one embodiment of the invention, the master uses random subsets of the unique set of sender keys (e.g., “P” keys) to provide the members with keys for authenticating itself and distributes the keys to the existing members so that they can correctly authenticate the new group member. In this embodiment, each present member is distributed the new members complementary key. In one embodiment of the invention, when all of the members of the group acknowledge the receipt of the new member's complementary key, then only the new member is allowed to join the group by providing the group with the necessary information.

In one embodiment of the invention, to keep all previous communications of a group from the new member, a new, shared key is generated and distributed to all of the current group host members. In this embodiment, the generation of the new key supports the concept of perfect forward secrecy to further increase the strength of the security design. The key can be time stamped with a time that indicated when it should start being used and the existing key be stopped from being used, so that there is no confusion of its usage.

In one embodiment of the invention, after all of the information that needs to be provided to all of the existing group members for adding a new member is distributed, the master host creates a temporary session key with the new member using, for example, the Diffie-Hellman algorithm and uses this session encryption key to securely provide the required information to the new member. In this embodiment, the new member is provided with a new unique set of sender keys (e.g., “P” keys) that allow the new member to create MACs for providing source authentication for message packets that it sends to the group. In addition, the new member is distributed a newly generated group encryption key that can be used whenever information needs to be encrypted while sending a message to the group. In this embodiment, the new member is given the entire set of complementary keys (excluding its own complementary key) corresponding to all of the other members of the group and is given all of the existing receiver MAC key subsets so that the new member is able to verify the source of communication from existing members. In the embodiment of having a temporary master host, the master host will not have its own complementary key and would initiate some other existing member of the group to directly send the master's complementary key to the new member. This other member would again set up a temporary session key with the new member using, for example the Diffie-Hellman algorithm and use this session key to securely provide the required information to the new member.

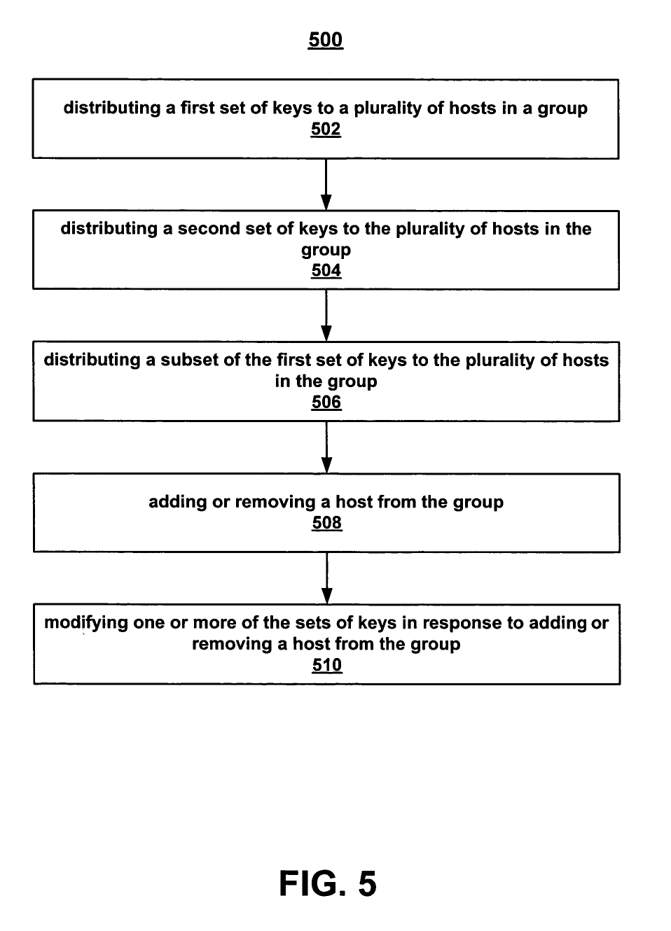

FIG. 5 is a data flow diagram of an exemplary process 500 for establishing a secure group-based communication environment for dynamic source authentication in accordance with embodiments of the present invention. The first step 502 of process 500 is distributing a first set of keys to a plurality of hosts in a group. For example, distributing a unique set of “P” keys to host one 301, host two 302, host three 303, and host four 304 of FIG. 4. The first set of keys is used, for example, to create MACs that are attached to outgoing messages for authenticating outgoing message packets.

The next step 504 is distributing a second set of keys to the plurality of hosts in the group. For example, distributing the sets of complementary keys to each host member of a particular group. The second set of keys are, for example, complementary keys used to re-key the first set of keys when, for example, a new member is added or removed from the group. In one embodiment of the invention, each member receives complementary keys for all members of the group beside itself.

The next step 506 is distributing a subset of the first set of keys to the plurality of hosts in the group. For example, distributing the subsets of the “P” keys for all of the members of the group. In one embodiment of the invention, each host receives unique subsets of the “P” keys generated for each of the other members of the group. In one embodiment of the invention, the size of the subset keys is determined by the statistical probability that members will collude. The steps 504 and 506 may be interchanged, & in this embodiment step 504.

The next step 508 is to add or remove a host from the group. For example, the group wants to add new members or eliminate particular members from the group.

The next step 510 is modifying the sets of keys (distributed in earlier steps, as also the group shared secret key that might have been used for encryption of the group communication) in response to adding or removing a host from the group. Re-keying the keys prevents old members from sending and reading messages to the group and also prevents new members from accessing messages from before the time they were added to the group. In one embodiment of the invention, when a member of the group is removed, the complementary key corresponding to the removed member is used to re-key the “P” keys and the subsets of the “P” keys, as also any shared secret key that might have been used for encryption of the group based communication.

In one embodiment of the invention, the complementary keys provide a mechanism for revoking a particular host's ability to receive any communication from the group or to spoof any new communication data traffic to that group, if the host is either removed or voluntarily leaves the group. In this embodiment, when a host leaves the group, a message (with an integrity maintaining mechanism, e.g., a MAC) is broadcast to all members of the group asking them to remove the particular user from the group. Then, each host of the group encrypts their “P” keys and their subsets of the “P” keys with the complementary key of the removed host.

In additional embodiments of the present invention, when a group size dynamically increases by a significant extent, the present security strength can be maintained (with respect to source authentication) by increasing the number of keys in the receiver set (e.g., the subset of the “P” keys). In one embodiment, for large groups, the sender may use a large number of keys. In this embodiment, a tree-based hashing technique can be used to reduce MAC processing overhead.

Furthermore, in one embodiment of the invention, at regular intervals, a shared group encryption is distributed by a temporary master host. This re-keying of the shared encryption key mitigates the risk of breaking the shared group key. In this embodiment, the key can be time stamped with a time that indicates when it should be used and when the existing key be stopped being used. In addition, the new shared group key can be generated with a random number generator that maintains perfect forward secrecy.

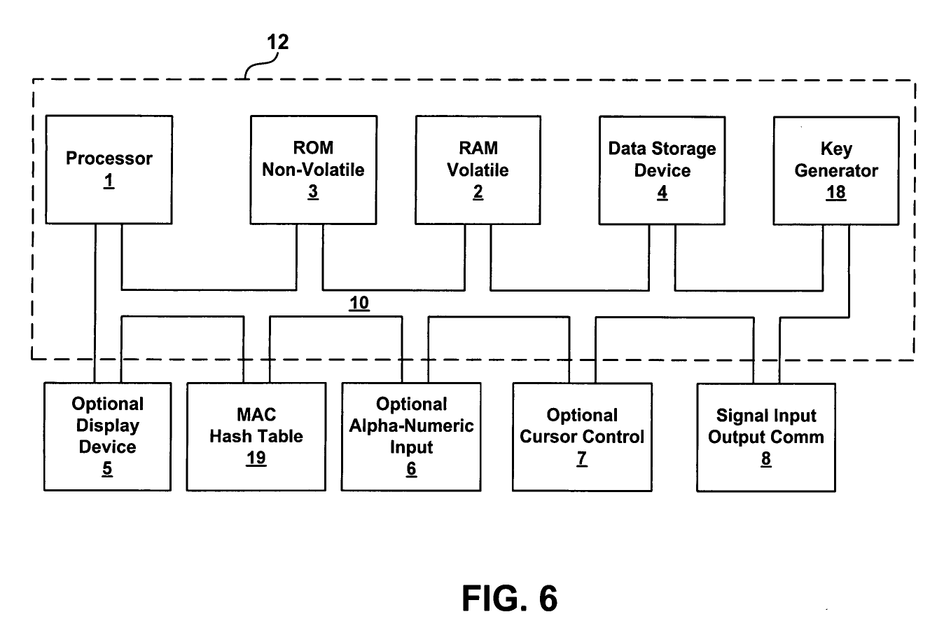

Referring now to FIG. 6, a block diagram of exemplary computer system 12 is shown. It is appreciated that computer system 12 of FIG. 6 described herein illustrates an exemplary configuration of an operational platform upon which embodiments of the present invention can be implemented. Nevertheless, other computer systems with differing configurations can also be used in place of computer system 12 within the scope of the present invention. For example, computer system 12 could be a server system, a personal computer or an embedded computer system such as a mobile telephone or pager system.

Computer system 12 includes an address/data bus 10 for communicating information, a central processor 1 coupled with bus 10 for processing information and instructions, a volatile memory unit 2 (e.g., random access memory, static RAM, dynamic RAM, etc.) coupled with bus 10 for storing information and instructions for central processor 1 and a non-volatile memory unit 3 (e.g., read only memory, programmable ROM, flash memory, EPROM, EEPROM, etc.) coupled with bus 10 for storing static information and instructions for processor 1. Computer system 12 may also contain an optional display device 5 coupled to bus 10 for displaying information to the computer user. Moreover, computer system 12 also includes a data storage device 4 (e.g., disk drive) for storing information and instructions.

Also included in computer system 12 of FIG. 6 is an optional alphanumeric input device 6. Device 6 can communicate information and command selections to central processor 1. Computer system 12 also includes an optional cursor control or directing device 7 coupled to bus 10 for communicating user input information and command selections to central processor 1. Computer system 12 also includes signal communication interface 8, which is also coupled to bus 10, and can be a serial port, a USB port or any other communication port or interface. Communication interface 8 can also include number of wireless communication mechanisms such as infrared or a Bluetooth protocol.

Computer system 12 also comprises a MAC hash table 19 configured to decode MACs used for group-based communications. Computer system 12 also comprises a key generator 18 for generating keys used for dynamic source authentication in a group-based communications environment. It is appreciated that computer system 12 can be part of a utility data center (UDC) that comprises a group-based communications environment.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and it's practical application, to thereby enable others skilled in the art to best utilize the invention and various embodiments with various modifications as are suited to the particular use contemplated. It is intended that the scope of the invention be defined by the Claims appended hereto and their equivalents.

1. A method for establishing secure group-based communication comprising:
distributing a first set of keys to a plurality of hosts for encrypting communication and for source authentication of group-based communication between said plurality of hosts; and
distributing a second set of keys to said plurality of hosts for dynamically modifying said first set of keys.

2. The method as recited in claim 1 further comprising:
distributing said second set of keys wherein a unique set of keys are distributed to each of said plurality of hosts.

3. The method as recited in claim 2 further comprising:
distributing said second set of keys wherein each of said plurality of hosts receives a unique key for each of said plurality of hosts except for itself.

4. The method as recited in claim 1 further comprising:
communicating between said hosts in a utility data center communications environment.

5. The method as recited in claim 1 further comprising:
authenticating a communication source from a host level.

6. The method as recited in claim 1 further comprising:
authenticating a communication source from an application level.

7. The method as recited in claim 1 further comprising:
adding a new host to said plurality of hosts and dynamically modifying said first set of keys in response to adding said new host.

8. The method as recited in claim 1 further comprising:
in response to removing one of said plurality of hosts, dynamically modifying said first set of keys.

9. The method as recited in claim 1 further comprising:
dynamically modifying said first set of keys at regular intervals with said second set of keys.

10. A method for establishing a secure group-based communication environment between a plurality of hosts comprising:
distributing a first set of keys to each of said plurality of hosts for encrypting communication between said hosts and for authenticating a source of communication between said plurality of hosts;
distributing a subset of said first set of keys to each of said plurality of hosts for validating said source of communication between said plurality of hosts; and
distributing a second set of keys to each of said plurality of hosts for dynamically modifying said first set of keys and said subset of said first set of keys.

11. The method as recited in claim 10 further comprising:
adding a new host to said plurality of hosts; and
dynamically modifying said first set of keys and said subset of said first set of keys.

12. The method as recited in claim 11 further comprising:
dynamically modifying said first set of keys and said subset of said first set of keys with a third set of keys generated in response to adding said new host.

13. The method as recited in claim 10 further comprising:
removing a host from said plurality of hosts;
dynamically modifying said first set of keys and said subset of said first set of keys.

14. The method as recited in claim 13 further comprising:
dynamically modifying said first set of keys and said subset of said first set of keys with a third set of keys generated in response to removing said host from said plurality of hosts.

15. The method as recited in claim 10 further comprising:
communicating between said plurality of hosts in a utility data center communications environment.

16. The method as recited in claim 10 further comprising:
validating said source of communication between said plurality of hosts at a host level.

17. The method as recited in claim 10 further comprising:
validating said source of communication between said plurality of hosts at an application level.

18. A computer readable medium comprising executable instructions which, when executed in a processing system, causes the system to perform the steps for a method of establishing secure group-based communication comprising:
distributing a first set of keys to a plurality of hosts for encrypting communication and for source authentication of group-based communication between said plurality of hosts; and
distributing a second set of keys to said plurality of hosts for dynamically modifying said first set of keys.

19. The computer readable medium as recited in claim 18 wherein said method further comprises:
distributing said second set of keys wherein a unique set of keys are distributed to each of said plurality of hosts.

20. The computer readable medium as recited in claim 19 wherein said method further comprises:
distributing said second set of keys wherein each of said plurality of hosts receives a unique key for each of said plurality of hosts except for itself.

21. The computer readable medium as recited in claim 18 wherein said method further comprises:
communicating between said hosts in a utility data center communications environment.

22. The computer readable medium as recited in claim 18 wherein said method further comprises:
authenticating a communication source from a host level.

23. The computer readable medium as recited in claim 18 wherein said method further comprises:
authenticating a communication source from an application level.

24. The computer readable medium as recited in claim 18 wherein said method further comprises:
adding a new host to said plurality of hosts and dynamically modifying said first set of keys in response to adding said new host.

25. The computer readable medium as recited in claim 18 wherein said method further comprises:
in response to removing one of said plurality of hosts, dynamically modifying said first set of keys.

26. The computer readable medium as recited in claim 18 wherein said method further comprises:
dynamically modifying said first set of keys at regular intervals with said second set of keys.
